(19) United States
(12) Patent Application Publication
(10) Pub. No.: US 2007/0136104 A1
(43) Pub. Date: Jun. 14, 2007

(54) Method for valuation of real and personal property

(75) Inventors: Paul S. Bowen, Hebron, CT (US); Clifton J. Lancaster, Avon, CT (US)

Correspondence Address: PEPE & HAZARD, LLP, 225 ASYLUM ST., HARTFORD, CT, 06103, US

(73) Assignee: The Hartford Steam Boiler Inspection and Insurance Company

(21) Appl. No.: 11/297,013

(22) Filed: Dec. 8, 2005

(51) Int. Cl. G06Q 40/00

(52) U.S. Cl. 705/4; 705/35

(57) ABSTRACT

A method for assessing differences in value distributions of real property and personal property coverage at an insured's site comprising collecting information on the amount of insurance coverage from various sources to provide a database and using the database information to create a distribution of values for the building and contents for each occupancy. A reference distribution is created for value of the building and contents for an occupancy based upon assessments of similar buildings and contents. The value distributions based upon the customer supplied valuation data are compared with reference distributions for the same occupancy and a report is generated which includes an assessment of the deviation of the customer contents value distribution from the reference distribution.

### BACKGROUND OF THE INVENTION

The present invention relates to assessment of the valuations of buildings and contents.

Insurers and customer parties are concerned with the valuation of property since premiums are dependent upon the customer value. A customer wants to avoid understating value to avoid a coinsurance situation in the event of a loss. An insurer is concerned that losses be not greater than the policy coverage.

Insurance-to-value (ITV) is a generic term used in the property insurance business to refer to the situation where the amount of insurance written on a property is approximately equal to the value of that property. Improper valuation can lead to a property being underinsured in which case, in the event of a loss, the customer will not recoup all of the damages. The property could be over insured in which case the customer is paying too much in premium.

Standard property insurance underwriting procedure calls for checking the reported property value against an estimated value for a property of similar description. If the difference exceeds a pre-determined amount the underwriter will investigate further to determine whether or not the reported property value is correct. Property value estimation tools exist in order to help the underwriter with this task.

In practice today, the ITV process is performed only for building value and not for personal property value (personal property is the contents of the building—equipment, stock, inventory, etc.) because it is much easier to estimate the value of a building than it is to estimate the value of its contents. This is due in part to the fact that the characteristics that are important in estimating building value—the type of construction (wood frame vs. masonry, etc.), size, quality of finish, and geographic location—are much easier to determine than the characteristics that define the value of contents. Presently, there are no good tools available for determining contents value.

A number of companies such as Marshall & Swift/Boeckh (M&S/B), R.S. Means, and Deloitte & Touche provide estimation tools for building value. But there are very few that provide tools for personal property valuation. Furthermore, M&S/B's contents valuation tool requires information that insurance companies do not typically obtain—information such as the gross sales of a company and number of employees. On the other hand building information such as size (square feet), construction type, occupancy and geographic location (i.e. street address, nature of neighborhood, safety equipment, etc.) is collected by the insurer as a normal part of the premium quoting process. This information is input into the building valuation tool and an average value for a building with those characteristics is output.

As a result of the lack of an effective valuation tool for commercial business personal property it is likely that there is an ITV problem within the property insurance industry today. At the very least, insurers do not know whether they have an ITV problem or not.

It is an object of the present invention to provide a unique method for building and personal property valuation.

It is also an object to provide such a method which makes use of information that a property insurer collects as part of the normal course of business.

Another object is to provide such a method which calculates a value for an individual building both in terms of real and personal property (i.e. building and contents value) and provides an assessment as to whether a property carrier has an ITV problem in its existing book of business.

### SUMMARY OF THE INVENTION

It has now been found that the foregoing and related objects may be readily attained in a method for assessing differences in value distributions of real property (building/structure) coverage and personal property (contents) coverage at an insured's site which collects information on the amount of insurance coverage from existing insurance policies, surveys and published reports to provide a database including the size and location of the insured's site, the nature of the business conducted at the site, the valuation of the building/structure and contents provided by the insured and/or its agent, and loss experience. This database information is used to create a distribution of values for both the building/structure and contents for each occupancy, and a reference distribution is created for value of the building/structure and contents at an insured's site based upon assessments of similar buildings/structures and contents.

The value distributions based upon the customer supplied valuation data are compared with reference distributions for the same type of occupancy in the region in which the insured's site is located, and, in the case of building/structure values, for buildings of a similar size and construction. A report is then generated which can include an assessment of the deviation of the customer contents value distribution from the reference distribution.

The assessment may be reported to the customer for possible revaluation of the property. Apparently invalid data are excluded from the database.

Desirably the report to the customer superimposes the reference and customer distributions to generate a graphic comparison and includes statistics showing the amount of deviation, the variability in the deviation, and the uncertainty surrounding the comparison between the two distributions. The customer's value distribution and the reference distribution may be transformed to facilitate this comparison.

As will be appreciated, the assessment desirably includes both real and personal property. However, it may be limited to either real or personal property.

### BRIEF DESCRIPTION OF THE DRAWINGS

FIG. 1 is a graphic illustration of customer location values fitted to a probability distribution curve;

FIG. 2 is a graphic illustration of comparison of a location distribution to a predefined value distribution for the occupancy;

FIG. 3 is a graphic representation of a value comparison for a machine shop occupancy;

FIG. 4 is a flow chart for the method of assessing existing customers;

FIG. 5 is a graphic illustration of one standard deviation to determine the range of acceptable values for machine shops;

FIG. 6 is a histogram for convenience stores and a fitted curve;

FIG. 7 is a histogram for supermarkets and a filled curve;

FIG. 8 is a histogram for all grocery stores and filled curve;

FIG. 9 is a graphic illustration of the distribution in FIG. 8 transformed to a normal distribution; and

FIGS. 10a and 10b are tabulations of appraisal data presented as dollars per square foot for convenience stores and supermarkets.

### DETAILED DESCRIPTION OF THE ILLUSTRATED EMBODIMENTS

Every property insurer has a list of locations (buildings) that it currently insures. The property valuation process for existing business in accordance with the present invention starts with an analysis of the insurer's entire book of business (as opposed to an individual building basis, which is conventional). All of the customer buildings in a particular occupancy are listed in terms of the reported real property (i.e., building) and personal property (i.e., contents) values. These two independent lists of values are fit to a probability distribution using standard goodness of fit tests.

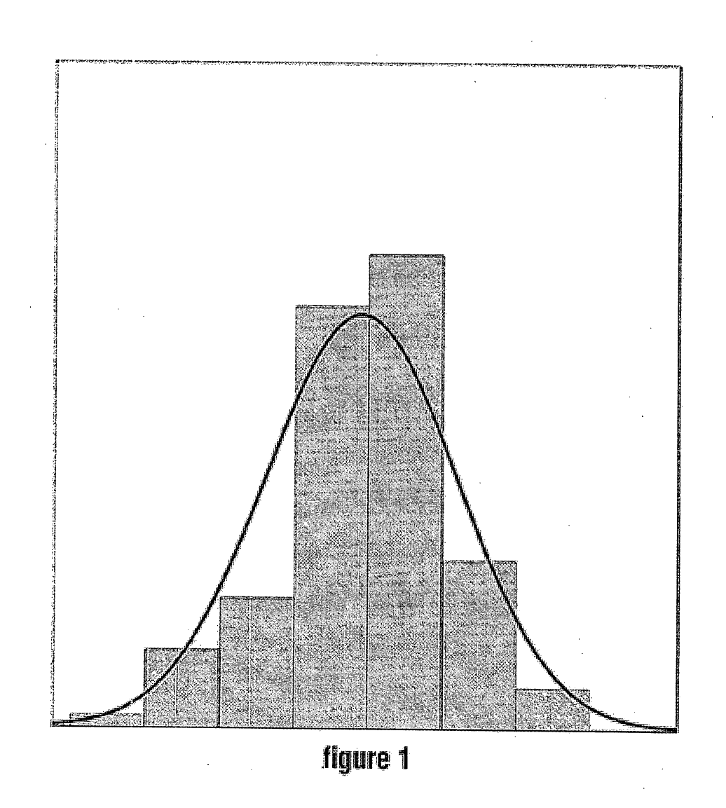

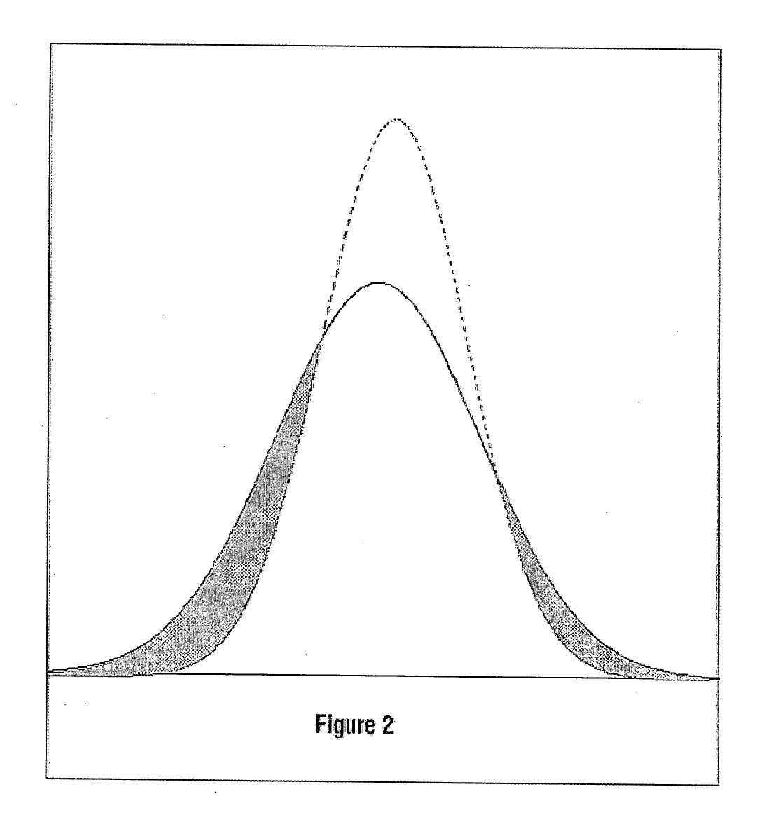

FIG. 1 illustrates the result of fitting a probability distribution to a set of reported personal property values. The units on the X-axis are in terms of dollars per square foot ($/ftˆ²) and the Y-axis is the probability that a building has that $/ftˆ² value. This distribution is compared to a pre-defined reference distribution that models the range of values for that occupancy as seen in FIG. 2. The reference distribution is defined according to a standard profile of the occupancy and a statistically valid sample of adjusted commercial property appraisal data is used as the quantitative basis for the distribution.

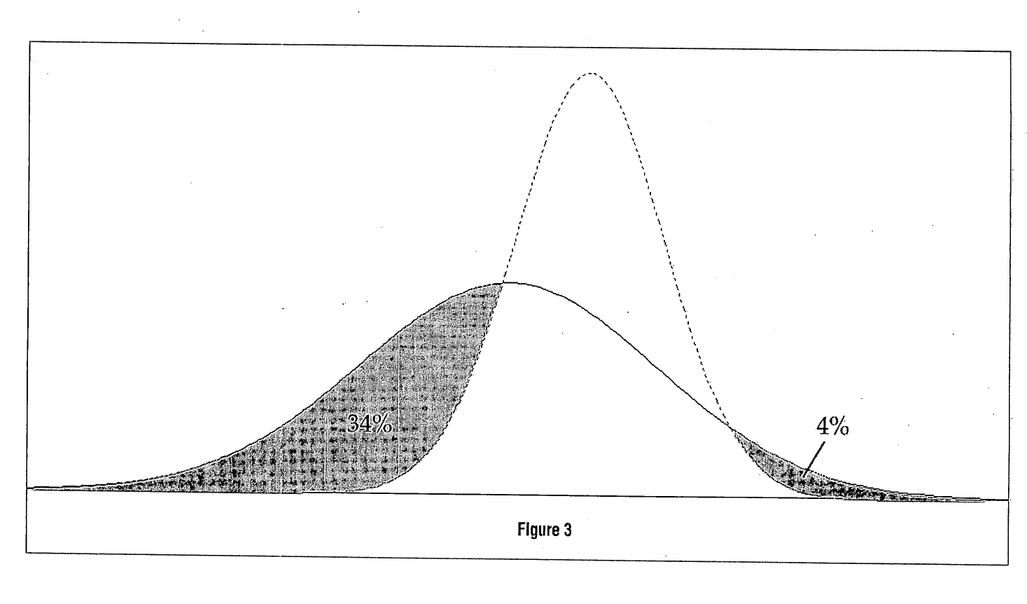

Although it is not shown in these graphs, each curve has a range of uncertainty around it. This uncertainty is given in terms of a range of probabilities for each building's value, in other words, each location has a range of probabilities that quantify how likely it is that the reported value for that location is correct. FIG. 3 shows an example of a value comparison for a machine shop occupancy. Approximately 34% of the locations in the customer data have values which are lower than the predicted distribution of machine shops, and approximately 4% are higher. The actual numbers are 34% and 4% plus and minus a small percentage (not shown here) which accounts for the uncertainty in each distribution. A summary of the quantitative difference between the reported value distribution and the reference distribution is given to the customer.

Given this information, an insurer's underwriting management team will look at some or all of the locations that fall outside the reference distribution to determine whether or not the reported values are incorrect. If the reported values are correct, then the other data that describe the building are analyzed to see if they are correct (square footage, construction type, etc.). If additional data is needed, the valuation process of the present invention provides the means to collect this data in the form of Internet searches and phone surveys.

Subsequent to the analysis, if the customer's underwriting management team determines that there are systemic problems with reported values and/or other building data, or if there are underwriting problems within this occupancy, then steps should be taken to correct them. As corrections are made over time, it is anticipated that the graph shown in FIG. 3 will come to look more like the graph in FIG. 2 indicating to the management team that the problem with incorrect values in this occupancy has been resolved.

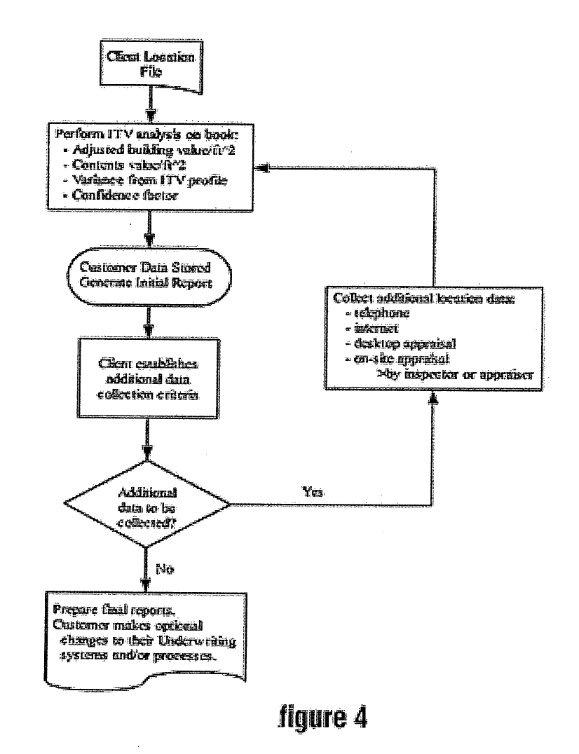

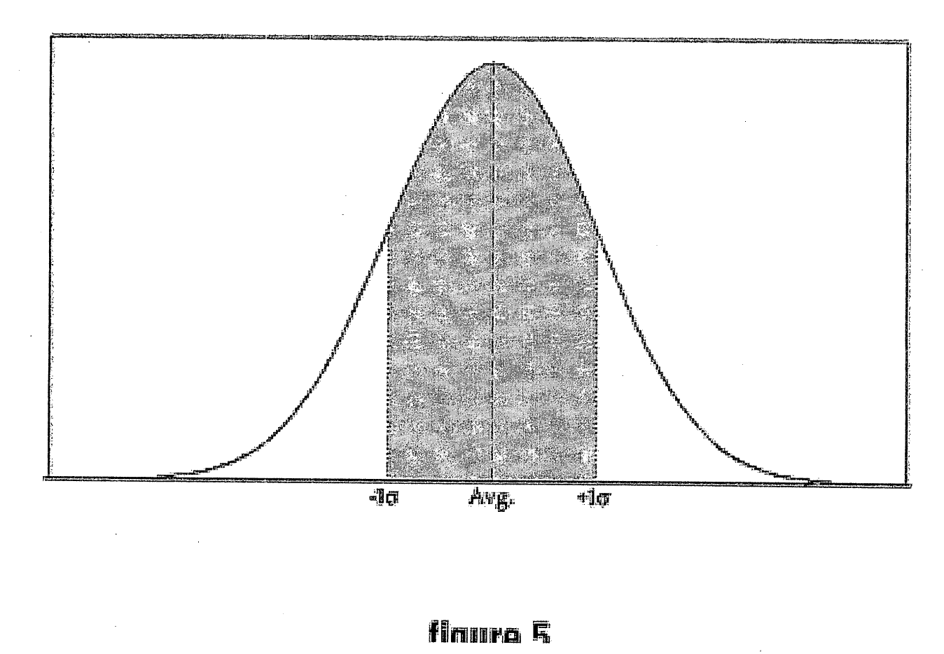

FIG. 4 is a flow chart of the method of the present invention. The entire distribution comparison process can be automated and implemented on an internal IT system. The output will be reports that are provided to the customer on a periodic basis.

As new property coverage is quoted, the underwriter refers to their ITV guidelines to ensure that the quoted premium is in line with the value of the building and its contents. These guidelines generally specify the maximum allowed deviation between the reported value and the estimated average value of the building and contents. If the reported value exceeds the estimated average value by some percentage (typically 15-20%), then the underwriter tries to determine whether the reported values are correct or not.

Since there are no practical and accurate contents value estimation tool available today, the underwriter either performs no ITV check on contents values or else they use a simple rule to determine whether the reported contents value is proportional to the building value (e.g., contents value must be at least 10% of the building value). While this type of ad hoc rule may be better than nothing, having a fixed rule of this type does not account for the widely varying contents values that can be found in a building depending upon the occupancy.

The method of the present invention is applicable to both building and contents value for new business. The reported values for a single location (representing the prospective new business) are compared to the average value and standard deviation from the reference value distribution for the occupancy. The customer can choose to use an existing rule of plus or minus N % from the average value (where N is determined by the customer), or it can use the standard deviation for determining a range of acceptable values around the reference average. The latter has the advantage of automatically varying the range of acceptable values since it is a function of the variability of the distribution rather than a fixed percentage. FIG. 4 shows an example of the average value and acceptable range of values based on the measure of plus or minus 1 standard deviation.

If so desired, the new business valuation process may be automated and accessed by the customer using a web browser-based interface.

The reference value distributions are specified on a per occupancy basis using the 4-digit Standard Industrial Coding (SIC) system. A profile is developed for each occupancy which specifies the “typical” building in this occupancy. This profile is developed for both real and personal property. The profile may contain information such as the quality of construction, floor height, presence or absence of a basement, density of equipment, etc.

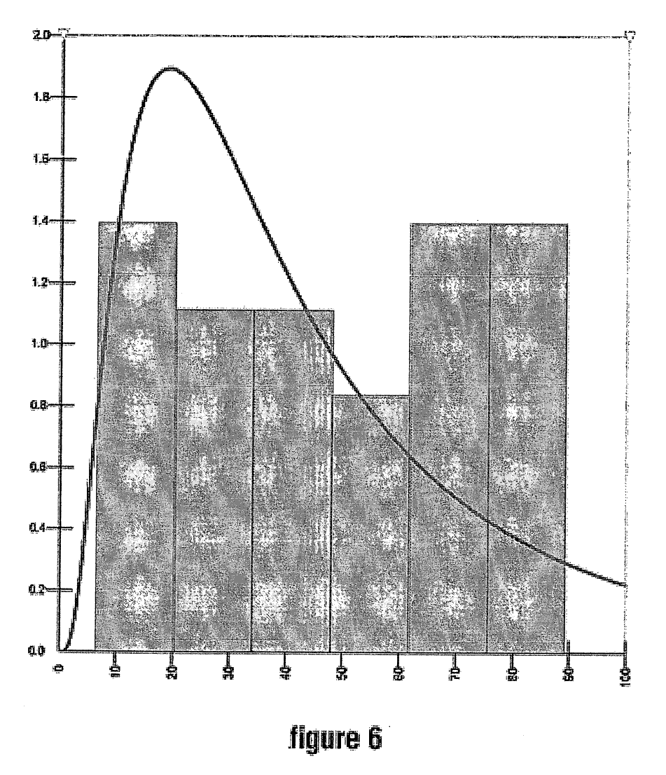

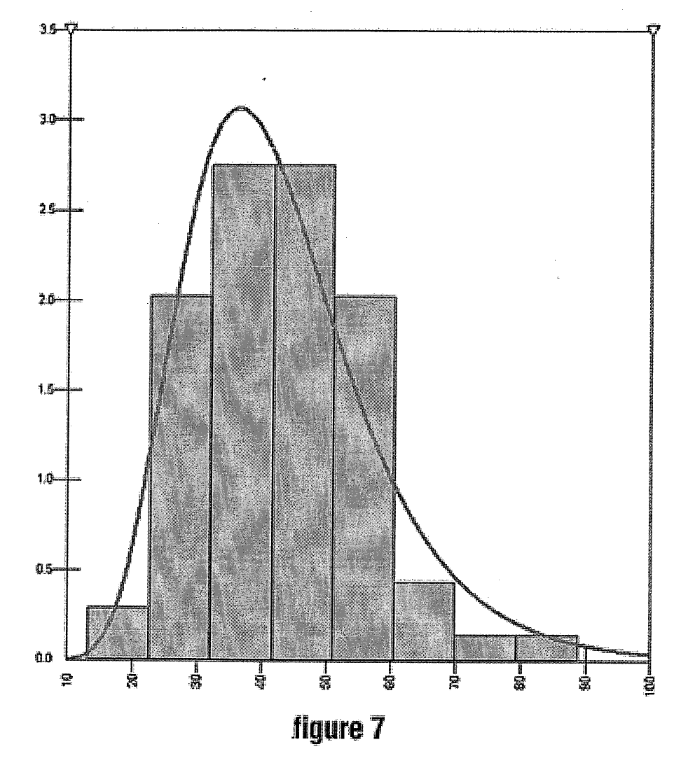

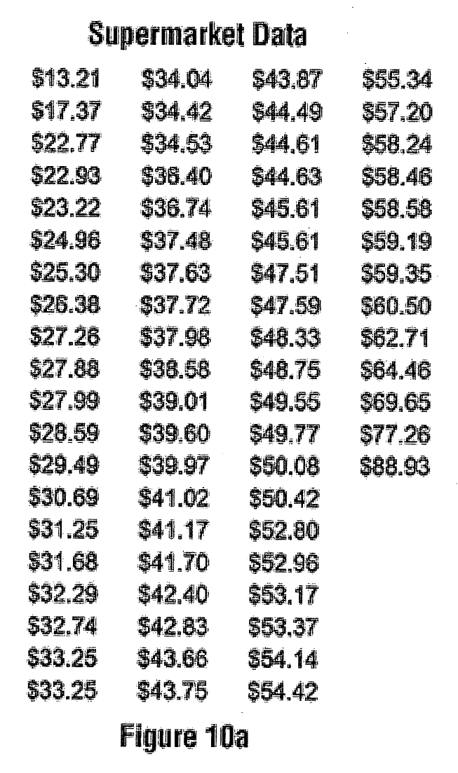

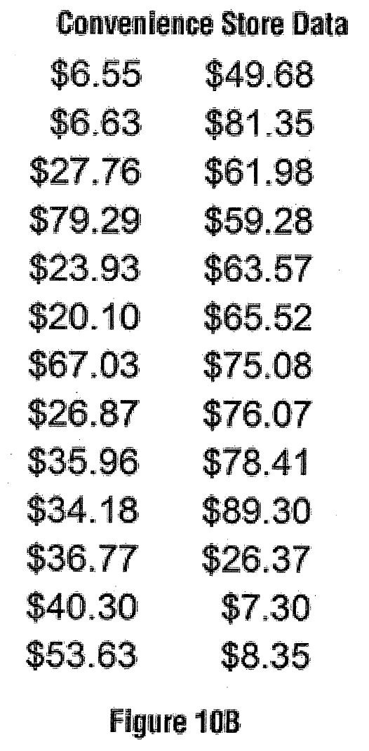

In most cases the reference value distributions are developed using data defined at various levels of detail. For example, a grocery store (SIC 5411) may be comprised of the two sub-occupancies called “convenience stores” and “supermarkets”. A statistically valid sample of appraisal data is collected for convenience stores and supermarkets according to the profiles defined for each (see FIGS. 10a and 10b). This data is compiled from actual commercial property appraisals from qualified appraisers and the individual appraisals are adjusted to be on a replacement cost basis. To minimize the chances for bias and error, a number of appraisal sources are used to obtain a representative data sample. The data is given in terms of dollars per square foot. A curve is fit to this data by performing a standard statistical goodness of fit test. This curve forms the value distribution for the sub-occupancy. FIG. 6 shows the histogram and fitted curve for convenience stores, and FIG. 7 shows the histogram and curve for supermarkets.

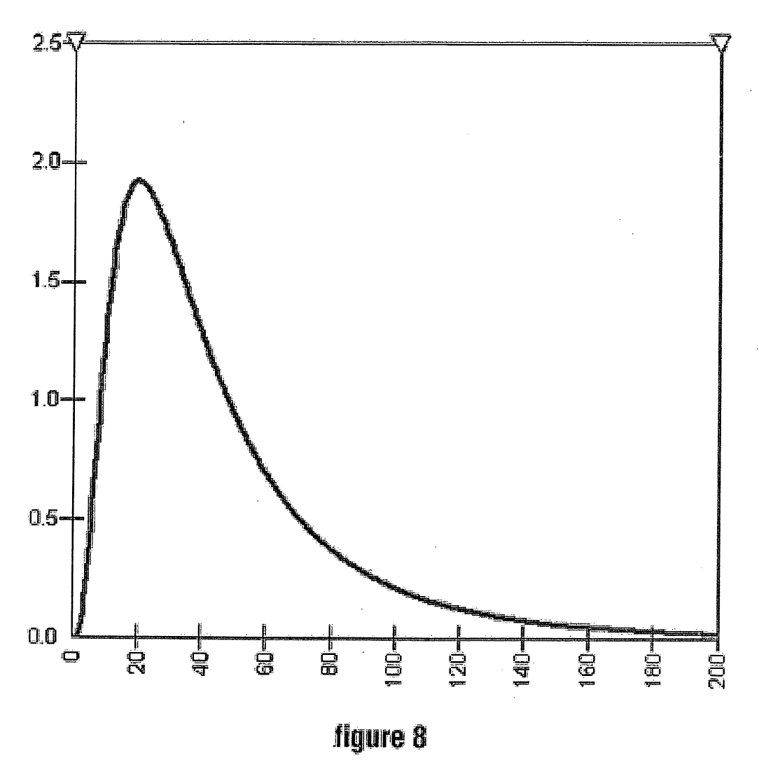

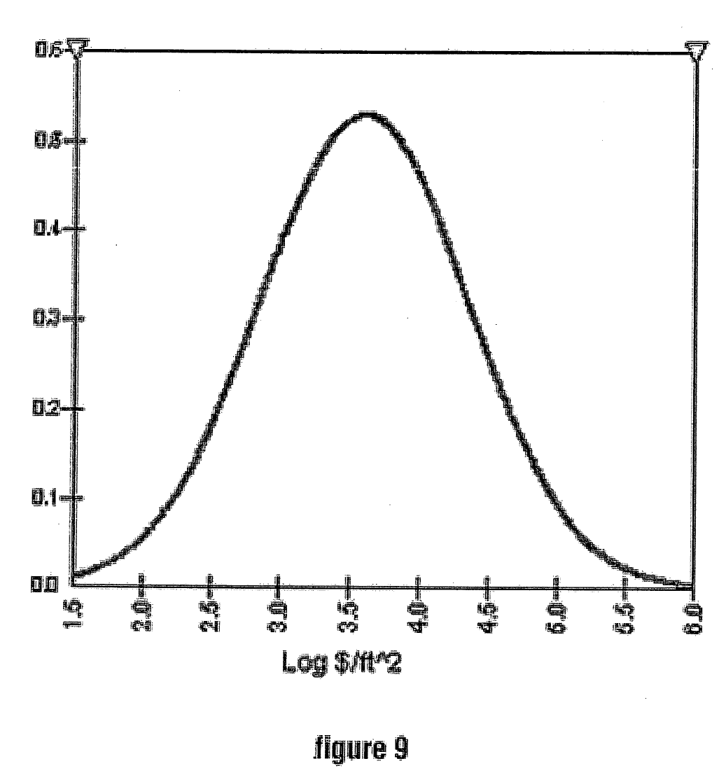

Statistics are acquired which define the relative percentage of the total population for each sub-occupancy within a geographic region. These statistics are used to combine the sub-occupancy value distributions into a single 4-digit SIC level distribution. For instance, convenience stores make up about 80% of grocery stores in the United States, and supermarkets make up the remainder. The value distributions for convenience stores and supermarkets are mathematically combined using an 80%/20% weighting respectively. The resulting curve shown in FIG. 8 represents the reference (ITV) value distribution for this occupancy.

If the reference value distribution is developed directly to the 4-digit SIC level, then the process is the same as that defined above except that the single value distribution represents 100% of the population for that occupancy.

Since each value distribution is a statistical entity, there is a measure of uncertainty associated with the distribution. This uncertainty is used when comparing the estimated values to the customer's actual reported values.

The process for developing the reported value distributions for the customer location data is as follows: a list of building data is acquired from a specific customer's database. This data set is sorted by occupancy, and records with invalid data are identified and removed from further analysis. A curve is fit to the reported building values a using standard statistical goodness of fit test. This curve represents the reported value distribution for this occupancy as indicated in FIG. 1.

Since each value distribution is a statistical entity, there is a measure of uncertainty associated with the distribution. This quantitative uncertainty estimate is used when comparing the estimated value distribution to the customer's actual reported value distribution.

For each occupancy there is a reference (ITV) value distribution and a customer's reported value distribution. Prior to the comparison, any necessary conversions are made to the distributions to facilitate a quantitative comparison.

The two distributions are then quantitatively compared with each other (see graphical example in FIG. 2) and the results are presented graphically to the customer along with statistics that show the amount of deviation and the variability in the deviation between the two curves. The customer's underwriting management uses this presentation of the differences between the two distributions to guide decision-making regarding their ITV process.

The method of the present invention affords the following advantages:
The analysis of a customer's existing business is performed on a portfolio level as opposed to individual building level, and using a value distribution rather than just an average value. So rather than just estimating the average value of a building as the existing valuation tools do, it can model the range of all possible values for both real and personal property values. This gives underwriting management a high-level view of how their distribution of values lines up against a reference distribution, thus helping it to identify and fix any systemic ITV problems in their business portfolio.
Since building and content values are modeled using a distribution, statistical tools such as variability, probability ranges and the quantification of uncertainty can be used by the underwriter to improve the accuracy and repeatability of the ITV estimates.
The valuation process gives the property underwriter a viable tool for estimating personal property values using information about the building and its contents that the insurer already collects as part of their quoting process. The amount of variability and uncertainty in the values for each occupancy is quantified and given to the underwriter in a simple form so that it can be used to make ITV decisions.
Distributions are defined according to a standard profile of the occupancy. If the insurer's portfolio differs from the standard profile for any reason, the distribution can be customized to fit that insurer's portfolio.

Thus, it can be seen from the foregoing detailed description that the present invention provides a unique method for building and personal property valuation. This method makes use of information that a property insurer collects as part of the normal course of business.

The method readily calculates a value for an individual building both in terms of real and personal property (i.e. building and contents value) and provides an assessment as to whether a property carrier has an ITV problem in its existing book of business. The method may be made available to customers by internet access.

Having thus described the invention, what is claimed is:

1. A method for assessing differences in value distributions of real property (building/structure) coverage and personal property (contents) coverage at an insured's site comprising:
(a) collecting information on the amount of insurance coverage from existing insurance policies, surveys and published reports to provide a database including the size and location of the insured's site, the nature of the business conducted at the insured's site, the valuation of the building/structure and contents provided by the insured and/or its agent, and loss experience;
(b) using said database information to create a distribution of values for both the building/structure and contents for each occupancy;
(c) creating reference distributions for value of the building/structure and for value of the contents of an occupancy based upon assessments of similar buildings/structures and contents;
(d) comparing the value distributions generated from the customer information with reference distributions for the same occupancy in the region in which the insured's site is located; and, in the case of building/structure values, for buildings of a similar size and construction; and
(e) generating a report including an assessment of the deviation of the customer contents value distribution from the reference distribution.

2. The method for assessing differences in value distributions for real and personal property in accordance with claim 1 including the step of reporting the assessment to the owner of the customer property for possible revaluation of the property.

3. The method of assessing differences in value distributions for real and personal property in accordance with claim 1 wherein there are excluded from said database apparently invalid data.

4. The method of assessing differences in value distributions for real and personal property in accordance with claim 1 wherein the customer's value distribution and the reference distribution are transformed in order to facilitate a quantitative comparison.

5. The method of assessing differences in value distribution for real and personal property in accordance with claim 1 wherein said report superimposes the reference and customer distributions to generate a graphic comparison.

6. The method of assessing differences in value distribution for real and personal property in accordance with claim 5 wherein there are included in the report statistics showing the amount of deviation, the variability in the deviation, and the uncertainty surrounding the comparison between the two distributions.

7. A method for assessing differences in value distributions of personal property (contents) coverage at an insured's site comprising:
(a) collecting information on the amount of insurance coverage for said personal property from existing insurance policies, surveys and published reports to provide a database including the size and location of the insured's site, the nature of the business conducted at the insured's site, the valuation of the contents provided by the insured and/or its agent, and loss experience;
(b) using said database information to create a distribution of values for contents for each occupancy;
(c) creating a reference distribution for value of the contents for an occupancy based upon assessments of similar buildings/structures and contents;
(d) comparing the value distribution generated from the customer information with a reference distribution for the same occupancy in the region in which the insured's site is located; and,
(e) generating a report including an assessment of the deviation of the customer contents value distribution from the reference distribution.

8. The method for assessing differences in personal property distributions in accordance with claim 7 including the step of reporting the assessment to the owner of the customer property for possible revaluation of the property.

9. The method of assessing differences in value distributions for personal property distributions in accordance with claim 7 wherein the customer's value distribution and the reference distribution are transformed in order to facilitate a quantitative comparison.

10. The method of assessing differences in value distributions for personal property value in accordance with claim 7 wherein said report superimposes the reference and customer distributions to generate a graphic comparison.

11. The method of assessing differences in value personal property distributions for value in accordance with claim 10 wherein there are included in the report statistics showing the amount of deviation, the variability in the deviation, and the uncertainty surrounding the comparison between the two distributions.

12. A method for assessing differences in value distributions of real property (building/structure) coverage at the insured's site comprising:
(a) collecting information on the amount of insurance coverage from existing insurance policies, surveys and published reports to provide a database including the size and location of the insured's site, the nature of the business conducted at the insured's site, the valuation of the building/structure and contents provided by the insured and/or its agent, and loss experience;
(b) using said database information in (1a) to create a distribution of values for both the building/structure;
(c) creating a reference distribution for value of the building/structure and contents for an occupancy based upon assessments of similar buildings/structures and contents;
(d) comparing the value distribution generated from the customer information with a reference distribution for the same occupancy in the region in which the insured's site is located, and for buildings of a similar size and construction; and
(e) generating a report including an assessment of the deviation of the customer contents value distribution from the reference distribution.

13. The method for assessing differences in value distributions real property coverage in accordance with claim 12 including the step of reporting the assessment to the owner of the customer property for possible revaluation of the property.

14. The method of assessing differences in value distributions of real property in accordance with claim 12 wherein the customer's value distribution and the reference distribution are transformed in order to facilitate a quantitative comparison.

15. The method of assessing differences in value distribution of real property value distributions in accordance with claim 12 wherein said report superimposes the reference and customer distributions to generate a graphic comparison.

16. The method of assessing differences in value distribution of real property in accordance with claim 15 wherein there are included in the report statistics showing the amount of deviation, the variability in the deviation, and the uncertainty surrounding the comparison between the two distributions.
